(19) United States
(12) Patent Application Publication
(10) Pub. No.: US 2008/0121664 A1
(43) Pub. Date: May 29, 2008

(54) Autoclavable piston chamber dip tube connection

(76) Inventors: Heiner Ophardt, Vineland (CA); Martin Anhuf, Kamp-Lintfort (DE)

Correspondence Address: RICHES, MCKENZIE & HERBERT, LLP, SUITE 1800, 2 BLOOR STREET EAST, TORONTO, ON, M4W 3J5, omitted

(21) Appl. No.: 11/979,365

(22) Filed: Nov. 1, 2007

(30) Foreign Application Priority Data
Nov. 14, 2006 (CA) 2567917

(51) Int. Cl. G01F 11/00; B67D 5/40; B67D 5/60

(52) U.S. Cl. 222/321.9; 222/382; 222/464.1

(57) ABSTRACT

An arrangement for coupling a plastic plug within an annular opening of a metal cylinder such that when the metal cylinder is heated, axial expansion of an end of the metal cylinder about the opening applies axially directed forces between axially spaced shoulder surfaces on the plastic plug to retain a plastic plug against rotation within the opening of the metal member.

### SCOPE OF THE INVENTION

This invention relates to an arrangement for coupling a plastic plug within an annular outlet of a metal member and, more particularly, to an arrangement for coupling a dip tube to an inlet end of a metal chamber.

### BACKGROUND OF THE INVENTION

Fluid dispensers are known with pump mechanisms which are to be subjected to autoclaving procedures for sterilization preferably on regular periodic intervals. Autoclaving requires subjecting the pump to elevated temperatures such as 120 degrees Celsius to 150 degrees Celsius for periods of time.

Piston pumps are known with a plastic sealing plug received inside an inlet end of a metal piston chamber forming element as for connecting with a dip tube which extends downwardly from the piston chamber forming member into a fluid reservoir. The plastic sealing plug and the dip tube permit fluid flow from the fluid reservoir to a chamber within the piston chamber forming member. In some of these prior art pumps, the dip tube is disposed to extend from the sealing plug member inclined at an angle to a central axis through the piston chamber forming element at a fixed rotational position relative to the central axis. The present inventor has appreciated that during autoclaving treatment when the piston chamber forming member with its dip tube secured thereto is subjected to elevated temperatures, the dip tube often becomes rotated from the desired rotational position resulting in difficulties in use such as difficulties in reinserting the piston chamber forming member and its dip tube back inside the reservoir for re-use.

### SUMMARY OF THE INVENTION

To at least partially overcome these disadvantages of previously known devices, the present invention provides an arrangement for coupling a plastic plug within an annular opening of a metal cylinder such that when the metal cylinder is heated, axial expansion of an end of the metal cylinder about the opening applies axially directed forces between axially spaced shoulder surfaces on the plastic plug to retain a plastic plug against rotation within the opening of the metal member.

Accordingly, in one aspect, the present invention provides a pump for dispensing fluids from a reservoir comprising:

a piston-chamber forming member formed from metal having a cylindrical chamber about a central axis, said chamber having a chamber wall, an outer open end and an inner end,

the chamber wall having an inner; surface and an outer surface,

a hollow annular sealing plug member formed from plastic fixedly received in the inner end of the chamber in sealed engagement with the inner surface of the chamber wall,

a hollow dip tube having an outer end coupled to plug member and an inner end spaced therefrom in communication with fluid in the reservoir wherein communication is provided from the inner end of the dip tube through the dip tube and the plug member to the chamber,

the hollow dip tube extending from the plug member inclined at an angle to the central axis at a fixed rotational position relative the central axis,

a portion of the chamber wall including the inner end and an axial end portion adjacent thereto the inner surface over the axial end portion extending radially inwardly and axially inwardly to the inner end,

the sealing plug member having a radially outwardly directed outer surface,

a radially inwardly annular groove in the outer surface of the sealing plug member receiving the inner end therein of the chamber wall with (a) an axially inwardly directed surface of the groove engaging the inner surface of the chamber wall of the axial end portion, and (b) an axially outwardly directed surface of the groove engaging the outer surface of the chamber wall of the axial end portion,

wherein under ambient temperatures the inner end engaged within the groove with the inner end applies radially inward pressure to the plug member in the groove by reason of a bias of the inner end to assume an inherent position having a radius about the central axis less than a radius of the groove thereby maintaining the plug member relative the piston-chamber forming member against relative rotation about the central axis,

wherein when subjected autoclaving treatment under temperatures exceeding 120 degrees Celsius thermal expansion of the axial end portion axially within the groove maintains the plug member relative the piston-chamber forming member against relative rotation about the central axis.

An object of the present invention is to provide an improved arrangement for coupling a dip tube to an inlet end of a metal chamber of a pump mechanism in a manner which resists relative rotation of the dip tube and chamber when heated to temperatures required for autoclaving procedures for sterilization.

### BRIEF DESCRIPTION OF THE DRAWINGS

Further aspects and advantages of the present invention will become apparent from the following description taken together with the accompanying drawings in which:

FIG. 1 is a schematic side view of a pump mechanism in accordance with a first preferred embodiment of the present invention;

FIG. 2 is an enlarged view of a portion of FIG. 1;

FIG. 3 is a view similar to FIG. 2 showing an assembly before deforming of the chamber tube; and

FIG. 4 is a view similar to FIG. 3 but of a second embodiment.

### DETAILED DESCRIPTION OF THE DRAWINGS

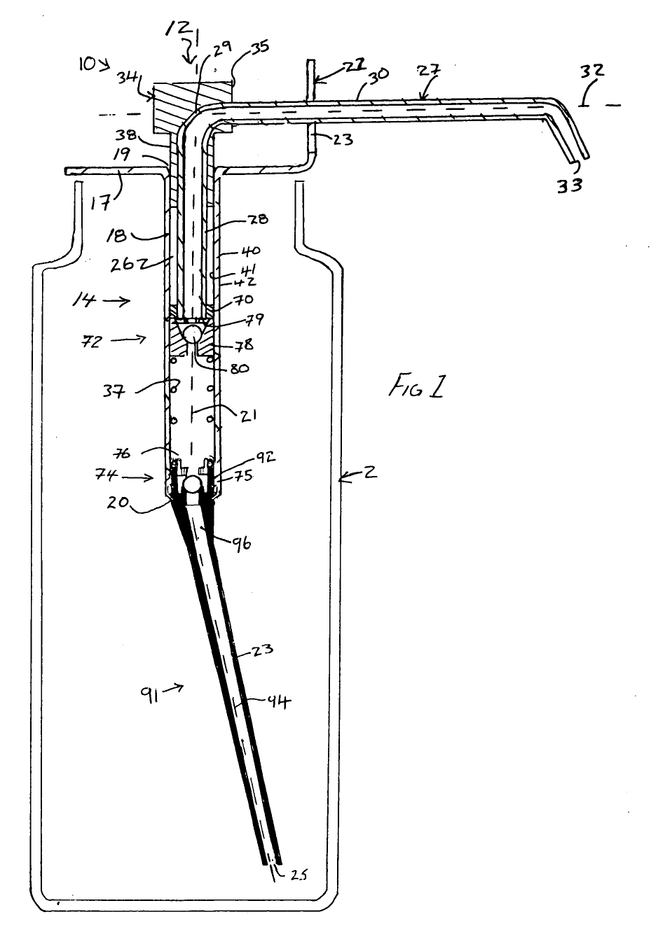

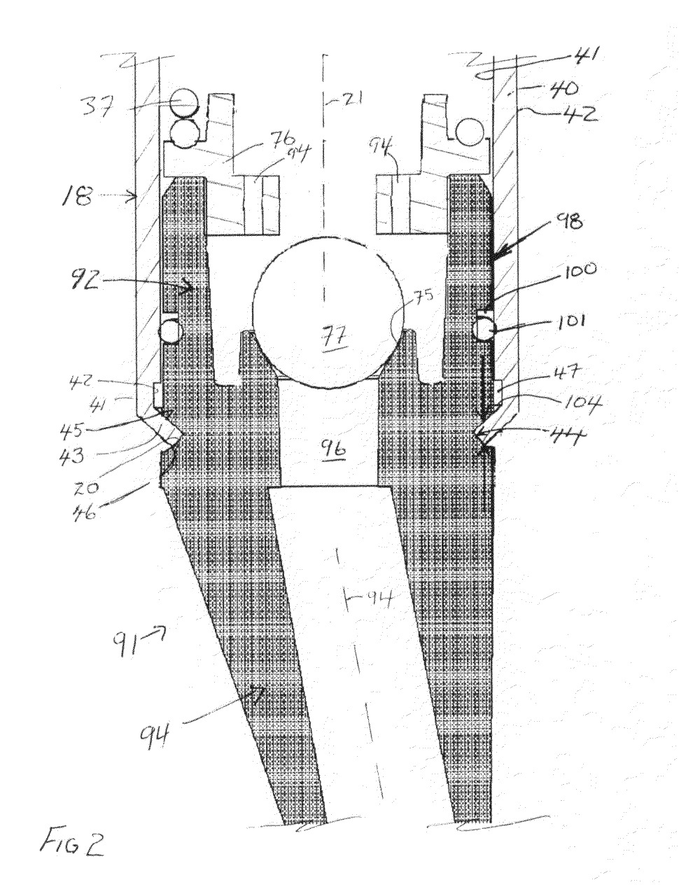

FIGS. 1 and 2 show a fluid dispenser in accordance with the present invention having a bottle 2 and a pump mechanism 10. The pump mechanism 10 includes a piston element 12 and a piston chamber forming member 14.

The piston chamber forming member 14 includes a cylindrical chamber tube 18 extending downwardly from an open upper end 19 to a inner end 20 about an axis 21 and defining a chamber 26 therein. The chamber tube 18 has a chamber wall 40 with a radially inwardly directed inner surface 41 and a radially outwardly directed outer surface 42. A dip tube element 91 has an upper annular sealing plug portion 92 secured inside the inner end 20 of the chamber tube 18 with a hollow dip tube portion 23 extending downwardly to an inlet 25 within the bottle 2. The dip tube portion 23 extends from the sealing plug portion 92 inclined at an angle to the central axis 21 at a fixed rotational position relative the central axis 21, preferably as shown with a longitudinal axis 94 through the dip tube portion 23 lying in a plane disposed radially of the central axis 21 and including a radial axis 32 through a discharge tube 27.

FIG. 2 best shows the connection between the lower end 20 of the chamber tube 18 and the sealing plug portion 92 of the dip tube element 91. The dip tube element 91 has a central bore 96 therethrough through the dip tube portion 23 and the annular sealing plug portion 92 to provide for communication from the inlet 25 of the dip tube portion 23 to the chamber 26. The sealing plug portion 92 has a cylindrical radially outwardly directed outer surface 98 sized to be of a diameter less than a diameter of the chamber 26. A radially inwardly extending annular groove 100 carries a resilient O-ring 101 to provide for a fluid impermeable seal between the sealing plug portion 92 and the inner surface 41 of the chamber wall 40 preventing fluid flow therebetween inwardly or outwardly.

The chamber wall 40 has an axial end portion 43 including the inner end 20 and a portion of the chamber wall 40 adjacent to the inner end 20. The axial end portion 43 is shown to be frustoconical extending radially inwardly as it extends axially inwardly towards the inner end 20.

The frustoconical axial end portion 43 is received within a radially inwardly extending annular groove 44 in the outer surface 98 of the sealing plug portion 92. This annular groove 44 in the outer surface of the sealing plug portion 92 has an axially inwardly directed surface 45 engaging the inner surface 41 of the chamber wall 40 of the axial end portion 43 and an axially outwardly directed surface 46 engaging the surface of the inner end 20 and, to some extent, the outer surface 42 of the chamber wall 40 of the axial end portion 43.

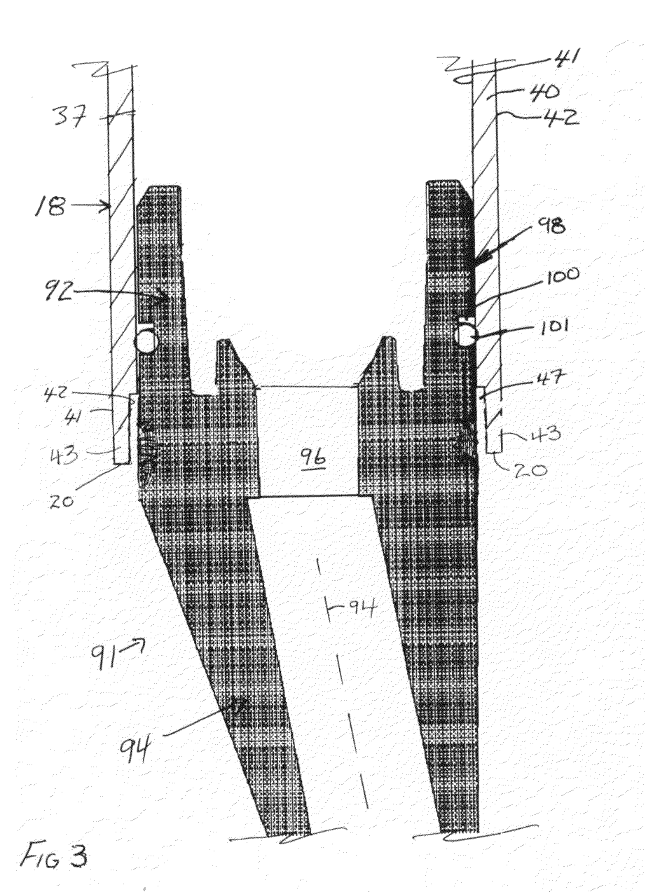

In a preferred method of manufacture, the piston chamber forming member 14 is formed as a separate metal member, however, having an initial configuration as shown in FIG. 3 with its cylindrical chamber tube 18 having the axial end portion 43 cylindrical. The dip tube element 91 is also formed as a separate plastic element. As seen in FIG. 3, the dip tube element 91 and the chamber tube 18 are assembled with the sealing plug portion 92 coaxially slid inside the open inner end 20 of the cylindrical chamber tube 18. From the position shown in FIG. 3, the axial end portion 43 is mechanically deformed to assume its frustoconical configuration shown in FIG. 2. The axial end portion 43 is mechanically deformed by forces applied so as to have its inner end 20 move axially inwardly past the position shown in FIG. 2 resiliently radially compressing the plastic plug portion 92. On release of the deforming forces, the inner end 20 is biased outwardly by the compressed plastic plug portion 92 and an equilibrium situation is reached with the inner end 20 applying radially inward pressures to the plastic plug portion 92 in the groove 44 by reason of a bias of the inner end 20 to assume an inherent position having a radius about the central axis less than a radius assumed by the groove 44 thereby assisting in maintaining the sealing plug portion 92 relative to the chamber tube 18 against relative rotation about the central axis 21. In mechanically deforming the axial end portion 43 of the chamber tube 18, the sealing plug portion 92 is preferably deformed so as to provide the groove 44 therein. Under normal ambient temperatures with the inner end 20 engaged within the groove 44, the inner end 20 applies radially inward pressures sufficient to maintaining the sealing plug portion 92 against relative rotation in the chamber tube 18.

The connection between the sealing plug portion 92 and the inner end 20 of the chamber tube 18 is adapted for autoclaving. Autoclaving is to be carried out under elevated temperatures for periods of time preferably with temperatures to be in the range, for example, of at least 100 degrees Celsius, or at least 120 degrees Celsius or at least 150 degrees Celsius. When autoclaving occurs under these elevated temperatures, the metal chamber tube 18 expands its inner diameter greater than the plastic sealing plug portion 92 expands its outer diameter with the result that the radial inward pressures that the axial end portion 43 of the chamber wall 40 applies to the sealing plug portion 92 are reduced. However, the metal axial end portion 43 when heated in autoclaving also expands in an axial direction, that is, increases its thickness in a direction parallel to the central axis 21 in an amount greater than the plastic sealing plug portion about the groove 44 expands in an axial direction. The increased thermal expansion of the axial end portion 43 in an axial direction within the groove 44 provides axially directed pressures which assist in maintaining the sealing plug portion 92 relative to the chamber tube 18 against relative rotation about the central axis 21 under elevated temperatures as experienced in autoclaving.

In the preferred embodiment, the axial end portion 43 is shown to have a reduced wall thickness measured radially, that is, as shown in FIG. 3 with the outer surface 42 of the chamber wall 40 being the same over the entirety of the chamber tube 18 but with the radially directed inner surface 41 of the axial end portion 43 being of increased radius compared to that of the inner surface 41 over the remainder of the chamber tube 18. This is advantageous so as to facilitate deforming of the axial end portion 43 to assume the preferred frustoconical orientation shown in FIG. 2 and to accommodate in an annular recess 47 formed between the inner surface 41 and the outer surface 98 of the sealing plug portion 92 any radially outwardly deformed portions 104 of the sealing plug portion 92 following deformation of the axial end portion 43.

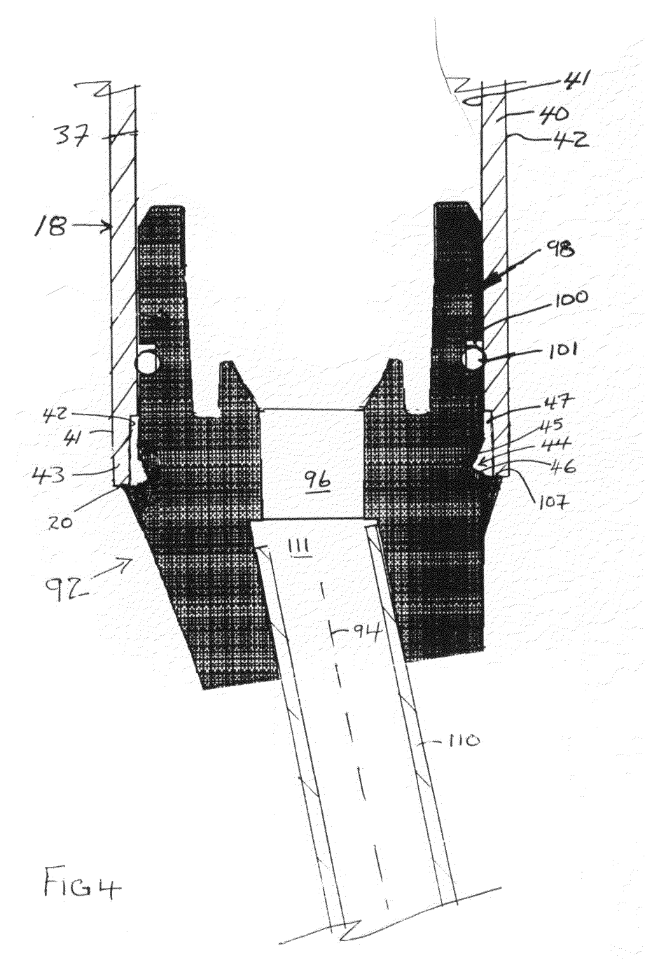

Reference is made to FIG. 4 illustrating a view similar to that shown in FIG. 3, however, in which the groove 44 is partially preformed in the sealing plug portion 92. The groove 44 as preformed is preferably sized so as to snugly receive the axial end portion 43 when deformed therein such that radially inward pressures are developed such that the axially inwardly directed surface 45 and outwardly directed surface 46 of the groove 44 tightly impinge on the inner surface 41 and the outer surface 42 respectively of the chamber wall 40 of the axial end portion 43. FIG. 4 also shows an annular stop shoulder 107 extending radially outwardly on the outer surface 98 of the sealing plug portion 92 to engage the inner end 20 of the chamber tube 18 in a desired assembled position locating the axial end portion 43 relative to the groove 44 ready for deforming.

The preferred embodiment of FIGS. 1 and 2 illustrates the dip tube element 91 as formed as integral member from plastic. It is to be appreciated that this is not necessary and the sealing plug portion 92 may be provided as a separate member as shown in FIG. 4 to which the dip tube as a separate element may be fixedly connected as, for example, by comprising a coaxial metal tube shown as 110 in FIG. 4 to be received within a downwardly open socket 111 as shown on the sealing plug portion 92 in FIG. 4.

The piston chamber forming member 14 includes a support flange 17 which extends radially outwardly about the open upper end 19 of the chamber tube 18. At a forward end, the support flange 17 is bent to extend upwardly as a front wall 22.

The piston element 12 has a vertical stem portion coaxially received within the cylindrical chamber 26 of the piston chamber forming member 14 thus forming with the chamber tube 18 a piston pump arrangement for dispensing fluid from the chamber 26 outwardly through a discharge tube 27. Reciprocal sliding of the piston element 12 within the piston chamber forming member 14 about the central axis 21 draws fluid in the bottle 2 upwardly through the dip tube 16 into the piston chamber forming member 14 from which it is dispensed out an outlet 33 of the dispensing tube 27 forming part of the piston element 12.

As seen in FIG. 1, the discharge tube 27 is a continuous tube, preferably of metal, which has a vertical portion 28 coaxial about the center axis 21. The discharge tube is bent 90 degrees in a curved portion 29 to extend normal the central axis as a horizontal portion 30 about the radial axis 32. The horizontal portion 30 merges into a downwardly directed nozzle outlet 33. The front wall 22 of the support flange 17 carries a vertical slotway 23 open at an upper end within which slotway 23 the forwardly extending horizontal portion 30 of the discharge tube 27 is disposed to locate the piston member 12 against rotation about the center axis 21 relative to the piston chamber forming member 14.

A plastic casing or locating member 34 disposed about the tube 27 to provide, amongst other things, cylindrically disposed, guide surfaces 38 disposed coaxially about the vertical portion 28 of the tube 27 to guide the piston element 12 coaxially about the center axis 21 in the chamber 26. The plastic casing 34 encases the curved portion 29 of the tube 27 and has a forward end 35 disposed about the horizontal portion 30 of the tube 27.

The piston element 12 fixedly carries about the inner end of the vertical portion 28 of the tube 27 an annular sealing ring member 70 which slidably sealingly engages the inner surface of the wall of the chamber 26 to prevent fluid flow therepast The pump mechanism 10 has inward of the sealing member 70 an outer ball valve 72 and an inner ball valve 74 each providing for one way flow outwardly therepast but preventing flow inwardly therepast.

An outer ball valve seat member 78 of the outer ball valve 72 is coaxially slidable in the chamber 26. A ball cage member 79 is secured to the outer ball valve seat member 78 above, outwardly of the outer ball valve seat member 78, and serves to retain a ball 80 above the outer ball valve seat member 78 yet permits fluid flow centrally therethrough.

The dip tube element 91 carries outwardly on the sealing plug portion 92 an inner ball valve seat member 75 for an inner ball valve 72. A ball cage member 76 is located above, outwardly of the inner ball valve seat member 75, and serves to retain a ball 77 above the inner ball valve seat member 75 yet permit fluid flow therethrough via axially extending ports 94.

A helical coil spring 37 has an inner end engage the ball cage member 76 urging it inwardly into the sealing plug portion 93. An outer end of the spring 37 engages on the outer ball valve seat member 78 of the outer ball valve 72 resiliently resisting downward movement of the outer ball valve seat member 78. The outer ball cage member 79 is sandwiched between the ball valve seat member 78 and the piston sealing ring member 70.

Movement of the piston element 12 axially inwardly to a retracted position relative the piston chamber forming member 14 urges the sealing ring member 70 into the outer ball cage member 79 compressing the spring 37. On release of the piston element 12, the spring 37 biases the piston element 12 to return to an extended position. Reciprocal movement of the piston element 12 draws fluid through the inner end 20 of the chamber 26 and dispenses it out the discharge outlet 33 of the tube 27.

The preferred embodiments show use of the metal tube 27 as part of the piston element 12. Use of a such a metal tube 27 is not necessary and a discharge tube with a horizontal portion for passage of fluid therethrough can be provided, as of plastic material, to have an outer journaling surface of circular cross-section upon which a removable plastic stroke stop member 38 may be secured for relative rotation.

The sealing plug portion 92 is also shown to provide the inner ball valve seat member 75. This is not necessary and in different embodiments, the inner ball valve seat member 75 may be provided as a separate element or, in respect of some pumps, may not be required at all.

The axial end portion 43 is shown in FIG. 2 as being generally frustoconical. This is not necessary and the axial end portion 43 may have any shape in which it extends radially inwardly into the plastic sealing plug portion 92.

While the invention has been described with reference to preferred embodiments, many modifications and variations will now occur to a person skilled in the art. For a definition of the invention, reference is made to following claims.

We claim:

1. A pump for dispensing fluids from a reservoir comprising:
a piston-chamber forming member formed from metal having a cylindrical chamber about a central axis, said chamber having a chamber wall, an outer open end and an inner end,
the chamber wall having an inner surface and an outer surface,
a hollow annular sealing plug member formed from plastic fixedly received in the inner end of the chamber in sealed engagement with the inner surface of the chamber wall,
a hollow dip tube having an outer end coupled to plug member and an inner end spaced therefrom in communication with fluid in the reservoir wherein communication is provided from the inner end of the dip tube through the dip tube and the plug member to the chamber,
the hollow dip tube extending from the plug member inclined at an angle to the central axis at a fixed rotational position relative the central axis,
a portion of the chamber wall including the inner end and an axial end portion adjacent thereto the inner surface over the axial end portion extending radially inwardly and axially inwardly to the inner end,
the sealing plug member having a radially outwardly directed outer surface,
a radially inwardly annular groove in the outer surface of the sealing plug member receiving the inner end therein of the chamber wall with (a) an axially inwardly directed surface of the groove engaging the inner surface of the chamber wall of the axial end portion, and (b) an axially outwardly directed surface of the groove engaging the outer surface of the chamber wall of the axial end portion,
wherein under ambient temperatures the inner end engaged within the groove with the inner end applies radially inward pressure to the plug member in the groove by reason of a bias of the inner end to assume an inherent position having a radius about the central axis less than a radius of the groove thereby maintaining the plug member relative the piston-chamber forming member against relative rotation about the central axis,
wherein when subjected autoclaving treatment under temperatures exceeding 120 degrees Celsius thermal expansion of the axial end portion axially within the groove maintains the plug member relative the piston-chamber forming member against relative rotation about the central axis.

2. A pump as claimed in claim 1 wherein in manufacture,
the plug member being is positioned within the axial end portion while the axial end portion is in a generally cylindrical configuration in which the inner surface of the axial end portion is coaxially slidable about the plug member and from such generally cylindrical configuration the axial end portion is mechanically deformed to assume its said inherent position in which it extends radially inwardly and axially inwardly to the inner end.

3. A pump as claimed in claim 2 wherein in manufacture,
a portion of the chamber wall including the inner end and an axial end portion adjacent thereto is mechanically deformed about the plug from a generally cylindrical configuration in which the inner surface of the axial end portion is coaxially about the plug to a frustoconical configuration in which the inner surface over the axial end portion extends radially inwardly and axially inwardly to the inner end with the inner end having a crimped inner diameter less than a diameter of the plug member.

4. A pump as claimed in claim 1 including a piston forming element having a piston portion coaxially slidably received in the chamber, wherein reciprocal sliding of the piston forming element relative the piston-chamber forming member drawing fluid from the reservoir through the dip tube portion into the chamber for discharge therefrom.

5. A pump as claimed in claim 4 wherein
the piston portion including a hollow stem with an inner portion coaxially slidably received in the chamber for reciprocal sliding inwardly and outwardly therein and with an outer portion extending outwardly of the open outer end of the chamber,
the stem defining therein a central passageway with an inner inlet end opening into the chamber and an outer end communicating with a discharge outlet on the outer portion of the stem out of the chamber,
a plastic annular sealing member fixedly secured to the inner end of the stem within the chamber axially spaced from the locating member,
the sealing member including an annular sealing flange slidably engaging an inner surface of the chamber wall forming a substantially fluid impermeable seal therewith on sliding of said piston forming element inwardly and outwardly,
a central bore through the sealing member providing for the inlet opening of the passageway to be in communication with the reservoir through the sealing member.

6. A pump as claimed in claim 5 wherein the stem includes a generally cylindrical metal tube extending continuously inwardly from the outer portion through the locating member along the central axis to an inner end of the tube which is coaxially received in an outwardly directed cylindrical socket provided on an outer end of the sealing member.

7. A pump as claimed in claim 6 wherein in the outer portion the metal tube is bent so as to form an extension of the tube extending generally radially outwardly from the central axis to the discharge outlet.

8. A pump as claimed in claim 5 including,
an inlet one-way valve between the reservoir and the chamber permitting fluid flow through the inner end of said chamber only from the reservoir to the chamber;
an outlet one-way valve between the chamber and the annular sealing flange permitting fluid flow through the central bore only from the chamber into the passageway,
wherein in operation,
(i) on the piston forming element sliding outwardly in said chamber fluid a vacuum is created in the chamber which closes the outlet one-way valve and that fluid is drawn into the chamber from the reservoir past the inlet one-way valve, and
(ii) on the piston forming element sliding inwardly into the chamber a pressure is created in the chamber which closes the inlet one-way valve and fluid is discharged from the chamber past the outlet one-way valve through the central bore into the inlet end of the passageway and the discharge outlet.
